(19) United States
(12) Patent Application Publication
(10) Pub. No.: US 2022/0201975 A1
(43) Pub. Date: Jun. 30, 2022

(54) SYSTEM AND DEVICE FOR MONITORING MARINE ANIMALS

(71) Applicant: KING ABDULLAH UNIVERSITY OF SCIENCE AND TECHNOLOGY, Thuwal (SA)

(72) Inventors: Muhammad Akram KARIMI, Thuwal (SA); Atif SHAMIM, Thuwal (SA); Rana Muhammad BILAL, Thuwal (SA); Hanguang LIAO, Thuwal (SA)

(21) Appl. No.: 17/601,470

(22) PCT Filed: Apr. 9, 2020
(86) PCT No.: PCT/IB2020/053418

§ 371 Date: Oct. 5, 2021

Related U.S. Application Data
(60) Provisional application No. 62/831,938, filed on Apr. 10, 2019.

(51) Int. Cl. A01K 11/00; A01K 61/00; H04B 11/00; H04B 7/26; H02S 10/40; H02S 40/38; H02N 2/18

(52) U.S. Cl. CPC A01K 11/006; A01K 61/00; H04B 11/00; H04W 84/18; H02S 10/40; H02S 40/38; H02N 2/186; H04B 7/26

(57) ABSTRACT

A system for monitoring marine animals includes a monitoring tag attachable to a marine animal. The monitoring tag includes a processor, a memory coupled to the processor, at least one communication interface, and at least one sensor. The processor is configured to store readings from the at least one sensor in the memory. The system also includes at least one communication receiver having a processor, a memory coupled to the processor, and at least one communication interface. The at least one communication receiver is configured to float in water. The processor of the monitoring tag is configured to determine, using the at least one sensor, whether the monitoring tag is within a communication range for radio frequency communication with the at least one communication receiver, and to transmit, via the at least one communication interface of the monitoring tag, the stored readings to the at least one communication receiver responsive to the processor of the monitoring tag determining that the monitoring tag is within the communication range for radio frequency communication with the at least one communication receiver.

### CROSS-REFERENCE TO RELATED APPLICATIONS

This application claims priority to U.S. Provisional Patent Application No. 62/831,938, filed on Apr. 10, 2019, entitled “SYSTEMS AND METHODS FOR ACQUIRING WIRELESS DATA FROM MARINE ANIMALS,” the disclosure of which is incorporated herein by reference in its entirety.

### BACKGROUND

### Technical Field

Embodiments of the disclosed subject matter generally relate to a cost- and power-efficient system and device for monitoring marine animals.

### Discussion of the Background

Changing climatic conditions and human activities are affecting sea life. Efforts are currently underway to study these changes by sensing environmental parameters (e.g., water density, temperature, pressure, oxygen level, pollutants, etc.), as well as activities of marine animals. Current devices for measuring environmental parameters or activities of marine animals are typically expensive, complex, and bulky. For example, one study involved using baited remote underwater video recording. This solution is expensive because it requires specialized underwater video cameras configured to trigger video recording when a marine animal eats the bait.

One particular problem encountered in measuring environmental parameters or activities of marine animals is how to get the measured data from sensors within the water to land. One solution to provide continuous data communication between the sensors and land employs a hybrid communication technique in which data is transmitted using acoustic waves while the sensor is underwater and using radio frequency waves when the sensor is at or near the surface of the water. Because marine animals typically spend most of their time below water, this solution consumes a large amount of power because the generation of acoustic waves while the sensor is underwater consumes a significant amount of power. Thus, this hybrid communication technique requires a large battery to maintain a long underwater operational life. Because the device attached to the marine animals should be as unobtrusive as possible, increasing the size of the battery is particularly disadvantageous in this environment.

Another solution involves using cables, such as optical fiber cables, to communicate sensor data from underwater sensors to land or a buoy. The use of cables can be problematic due to marine animals or debris in the water that can sever the cables. Yet another solution involves placing sensors on marine animals and then later removing the sensors for offline reading of the sensor data. This is a very resource-intensive in terms of time and costs, and the data cannot be accessed until the marine animal is located and the senor removed.

Thus, there is a need for systems and methods for monitoring marine animals that exhibits low power consumption and provides sensor readings on a timely basis relative to when the sensor readings were taken.

### SUMMARY

According to an embodiment, there is a system for monitoring marine animals includes a monitoring tag attachable to a marine animal. The monitoring tag includes a processor, a memory coupled to the processor, at least one communication interface, and at least one sensor. The processor is configured to store readings from the at least one sensor in the memory. The system also includes at least one communication receiver having a processor, a memory coupled to the processor, and at least one communication interface. The at least one communication receiver is configured to float in water. The processor of the monitoring tag is configured to determine, using the at least one sensor, whether the monitoring tag is within a communication range for radio frequency communication with the at least one communication receiver, and to transmit, via the at least one communication interface of the monitoring tag, the stored readings to the at least one communication receiver responsive to the processor of the monitoring tag determining that the monitoring tag is within the communication range for radio frequency communication with the at least one communication receiver.

According to another embodiment, there is a tag for monitoring a marine animal. The monitoring tag comprises a processor, a memory coupled to the processor, at least one communication interface, and at least one sensor. The processor is configured to store readings from the at least one sensor in the memory. The processor is configured to determine, using the at least one sensor, whether the monitoring tag is within a communication range of at least one communication receiver, and to transmit, via the at least one communication interface, the stored readings to the at least one communication receiver responsive to the processor determining that the monitoring tag is within the communication range of the at least one communication receiver.

According to a further embodiment, there is a method for monitoring a marine animal using a monitoring tag attached to the marine animal. The monitoring tag obtains a reading using at least one sensor of the monitoring tag. The reading is stored in a memory of the monitoring tag. A processor of the monitoring tag determines whether the monitoring tag is within a communication range for radio frequency communication with at least one communication receiver. The stored readings are transmitted via at least one communication interface of the monitoring tag using radio frequency communication to the at least one communication receiver responsive to the processor determining that the monitoring tag is within the communication range for radio frequency communication with the at least one communication receiver.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a block diagram of a system for monitoring marine animals according to embodiments;

FIG. 2 is a block diagram of a monitoring tag according to embodiments;

FIG. 3 is a block diagram of a communication receiver according to embodiments;

FIG. 4 is a block diagram of additional components of a system for monitoring marine animals according to embodiments;

FIG. 5 is a flow diagram of a method for monitoring marine animals according to embodiments;

FIG. 6 is a schematic diagram of a monitoring tag antenna according to embodiments;

FIG. 7 is a schematic diagram of a communication receiver according to embodiments;

FIG. 8 is a schematic diagram of a communication receiver antenna according to embodiments; and

FIG. 9 is a schematic diagram of a communication receiver antenna on a housing according to embodiments.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of systems and devices for monitoring marine animals.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

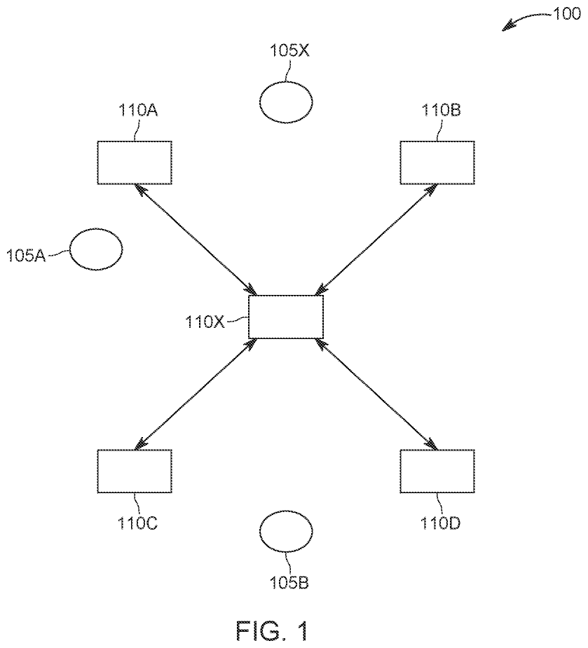

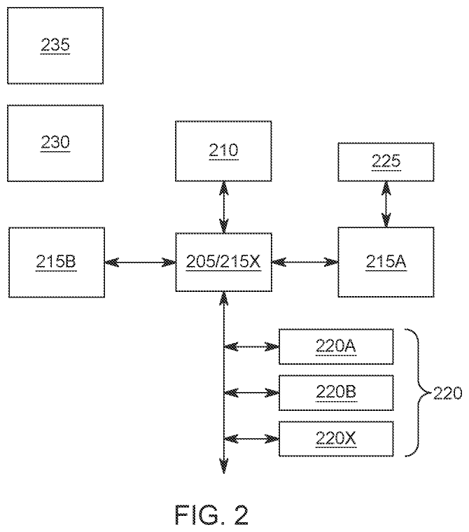

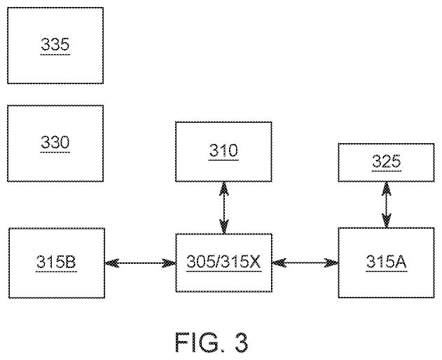

A system for monitoring marine animals will now be described in connection with FIGS. 1-3. The system includes a monitoring tag 105A-105X attachable to a marine animal. As illustrated in FIG. 2, the monitoring tag 105A-105X comprises a processor 205, a memory 210 coupled to the processor 205, at least one communication interface 215, and at least one sensor 220. The processor 205 is configured to store readings from the at least one sensor 220 in the memory 210. The system 100 also includes at least one communication receiver 110A-110X. As illustrated in FIG. 3, the at least one communication receiver 110A-110X comprises a processor 305, a memory 310 coupled to the processor 305, and at least one communication interface 315. The at least one communication receiver 110A-110X is configured to float in water. The processor 205 of the monitoring tag 105A-105X is configured to determine, using the at least one sensor 220, whether the monitoring tag 105A-105X is within a communication range for radio frequency communication with the at least one communication receiver 110A-110X. The processor 205 of the monitoring tag 105A-105X is also configured to transmit, via the at least one communication interface 215 of the monitoring tag 105A-105X, the stored readings to the at least one communication receiver 110A-110X responsive to the processor 205 of the monitoring tag 105A-105X determining that the monitoring tag 105A-105X is within the communication range for radio frequency communication with the at least one communication receiver 110A-110X.

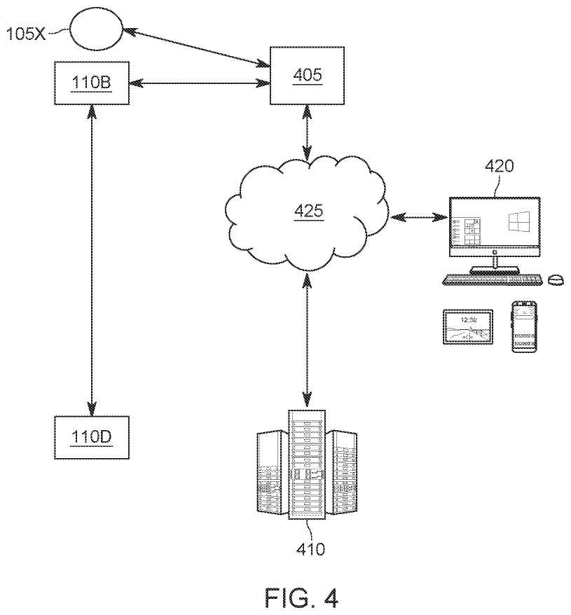

As will be appreciated from FIG. 1, the system 100 can include a number of communication receivers 110A-110X, which can be communicatively coupled with each other in order to forward sensor readings to the land, which will be described in more detail below in connection with FIG. 4. Thus, as a marine animal having an attached monitoring tag moves throughout the water, the marine animal can communicate, when the monitoring tag is within communication range of one of the communication receivers 110A-110X, the sensor readings to the nearest one of the communication receivers 110A-110X, which allows the monitoring tag to conserve energy during the communication of the sensor readings.

There are a number of ways for the monitoring tag 105A-105X to determine whether it is in communication range of one of the communication receivers 110A-110X, including using the communication interface 215 itself and/or using a pressure sensor. For example, the communication interface 215 can scan for radio frequency broadcasts from one or more of the communication receivers 110A-110X and when the received signal strength and/or signal-to-noise ratio of the broadcast is at or above a threshold value, the processor 205 can determine that the monitoring tag 105A-105X is within communication range of one of the communication receivers 110A-110X. Referring again to FIG. 2, one of the sensors 220 can be a pressure sensor and pressure readings can be used to determine whether the monitoring tag 105A-105X is within communication range. For example, when the pressure readings are at or below a predetermined pressure threshold value, the processor 205 can determine that one of the communication receivers 110A-110X is within communication range. In either case, the monitoring tag does not need to be at the surface of the water to be within the communication range of one of the communication receivers 110A-110X, and instead the monitoring tag can be close enough to the surface that the radio frequency transmissions and broadcasts from one of the communication receivers are sufficiently strong (i.e., they are not too attenuated by the water) that the monitoring tag can communicate the sensor readings.

Additional aspects of the monitoring tag will now be addressed in connection with FIG. 2. In the illustrated embodiment, there are three communication interfaces, 215A, 215B, and 215X. Although the illustrated embodiment includes the processor 205 and one of the communication interfaces 215X as being integrated in a single component, the processor 205 can alternatively be a separate component. In one embodiment the three communication interfaces include a Bluetooth interface, a wireless macro network interface (e.g., GSM, GPRS, LTE, etc.), and a LoRa (Long Range) interface. Those skilled in the art will recognize that a LoRa communication interface is a long range, low power wireless communication technique that uses spread spectrum modulation.

In one embodiment the processor 205 employs a priority order for determining which communication interface to employ. In one example this can involve having the wireless macro network interface having the highest priority, the LoRa interface having an intermediate priority, and the Bluetooth interface having the lowest priority. In this example, once the monitoring tag 105A-105X determines it is in communication range of one of the communication receivers 110A-110X, the processor 205 first attempts to communicate using the wireless macro network interface, and if this is not possible or not successful, the processor 205 then attempts to communicate with the LoRa interface. If neither of these are possible nor successful, the processor 205 then attempts to communication using the Bluetooth interface. It should be recognized that when the wireless macro network interface is employed, the monitoring tag 105A-105X communicates directly with a communication receiver in the form of a wireless macro network radio tower, whereas the LoRa and Bluetooth interfaces are used to communicate directly with one of the water-based communication receivers 110A-110X.

In the illustrated embodiment the communication interface 215A is a wireless macro network, and accordingly a user identification card, such as a Subscriber Identity Module (SIM) or Universal SIM (USIM) is operatively coupled to the communication interface 215A so that the monitoring tag 105A-105X can access and communicate over the wireless macro network. As will be described in more detail below in connection with FIG. 3, the wireless macro network interface can be used to communicate directly with a communication receiver on land, such as a wireless macro network radio tower.

The at least one sensor 220 can comprise any number of sensors, which are selected for whichever parameters that are desired to be measured. In one embodiment, the sensors can include a temperature sensor, pressure sensor, accelerometer, and a magnetometer. Additionally, the monitoring tag can include a battery voltage sensor to determine the current voltage produced by the battery 230.

The monitoring tag 105A-105X can also include a Global Navigation Satellite System (GNSS) communication interface (e.g., a GPS, GLONASS, Galileo, and/or Beidou communication interface) for obtaining the current location of the monitoring tag 105A-105X when it is at the surface of the water (due to the relatively low strength of GNSS signals the monitoring tag must be very close to or at the water surface to successfully receive the signals).

The readings are stored in the memory 210 of the monitoring tag 105A-105X along with a timestamp of when the readings were obtained. The timestamps can be obtained from a clock in the monitoring tag, which can be started using a Bluetooth low energy (BLE) characteristic, on which a specific value can be written to make the monitoring tag 105A-105X start operation. Alternatively, the clock can be synchronized before starting operation of the monitoring tag 105A-105X, and then the monitoring tag 105A-105X maintains the clock. Further, sampling intervals can be set for obtaining readings from each of the sensors, and the sampling interval of one or more of the sensors can be set to zero or off if data is not be to collected from the particular sensor, which saves power when the particular sensor is not being used.

The monitoring tag 105A-105X can further include an ambient energy collection device 235, which can be a solar panel and/or a kinetic motion energy collection device (e.g., a piezo electric device that generates energy due to bending). The ambient energy collection device 235 can be employed to charge the battery 230, thus prolonging the useful life of the monitoring tag 105A-105X.

In an embodiment, the monitoring tag 105A-105X can be attached to a marine animal using an adhesive that is selected so that it detaches from the marine animal around the end of the rated lifetime of the battery 230. Thus, for example, a first side of the monitoring tag 105A-105X has an adhesive and is configured for attachment to the marine animal and the battery 230 and other electronics can be arranged on a second side of the monitoring tag 105A-105X, the second side being opposite of the first side. The particular adhesive that is used can be determined by simulating the desired water environment and testing one or more adhesives until one is identified that fails around the useful lifetime of the battery to be employed. The monitoring tag 105A-105X is designed to be buoyant, and thus detaching the monitoring tag 105A-105X from the marine animal results in it floating to the water surface so that the readings can be offloaded by communication with one of the communication receivers 110A-110X. This is particularly advantageous for marine animals that do not, or only infrequently, rise within the water close enough to the surface to successfully communicate with one of the communication receivers 110A-110X.

The monitoring tag 105A-105X described above is particularly advantageous because it requires a relatively low amount of power to communicate its readings to a communication receiver 110A-110X compared to using ultrasonic communications. If, however, more frequent reporting of readings is desired, the monitoring tag 105A-105X can also include an ultrasonic communication interface. In this case, the monitoring tag 105A-105X will initially attempt to communicate the readings using one or more radio frequency interfaces and if that is unsuccessful then the ultrasonic communication interface is employed.

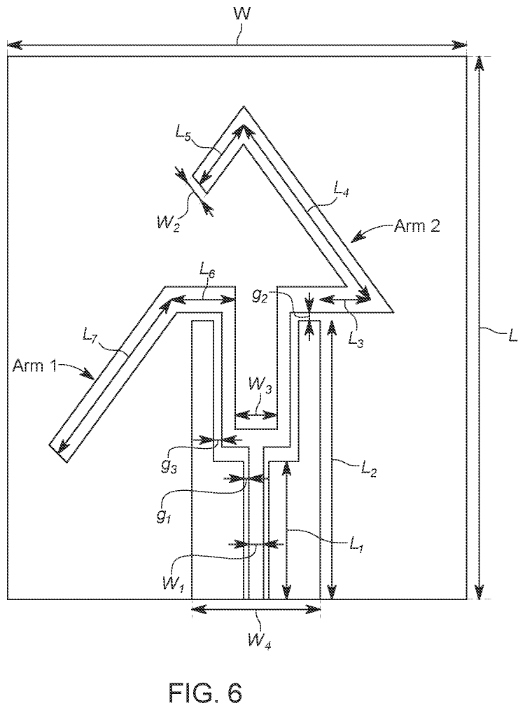

It should be recognized that FIG. 2 is a block diagram and does not illustrate all of the components of the monitoring tag 105A-105X. For example, the monitoring tag 105A-105X can include one or more antennas, a particular implementation of which will be described in more detail below in connection with FIG. 6. The monitoring tag 105A-105X can also include a data and/or charging port for exchanging data and/or charging the battery 230. The data and/or charging port can be, for example, a micro USB port. Further, the monitoring tag 105A-105X can include a number of passive components, such as resistors and capacitors, as well as buck/boost converters and low dropout (LDO) voltage converters. The communication interfaces 215A and 215B can communicate with the processor 205 using, for example, a UART connection and the sensor(s) 220 can communicate with the processor 205 using, for example, an I2C bus.

The components of the monitoring tag 105A-105X can be arranged on a flexible substrate. This is particularly advantageous because it allows the monitoring tag 105A-105X to conform to a shape of the marine animal to which the monitoring tag is attached, which decreases the likelihood that the monitoring tag 105A-105X is inadvertently detached as the marine animal moves through the water.

Additional details of the communication receivers 110A-110X will now be addressed in connection with FIG. 3. The communication receivers 110A-110X include communication interfaces corresponding to those of the monitoring tag 105A-105X. Thus, in one implementation the communication interfaces 315A-315X include a wireless macro network interface 315A, a LoRa interface 315B, and a Bluetooth interface 315X. As will be described in more detail below in connection with FIG. 4, the wireless macro network interface can be used to communicate directly with a communication receiver on land, such as a wireless macro network radio tower. Similar to the monitoring tag 105A-105X, the processor 305 and communication interface 315X can be integrated into a single component, as illustrated in the figure, or can be implemented as separate components. In the illustrated embodiment the communication interface 315A is a wireless macro network, and accordingly a user identification card, such as a SIM or USIM, is operatively coupled to the communication interface 315A so that the communication receiver 110A-110X can access and communicate over the wireless macro network.

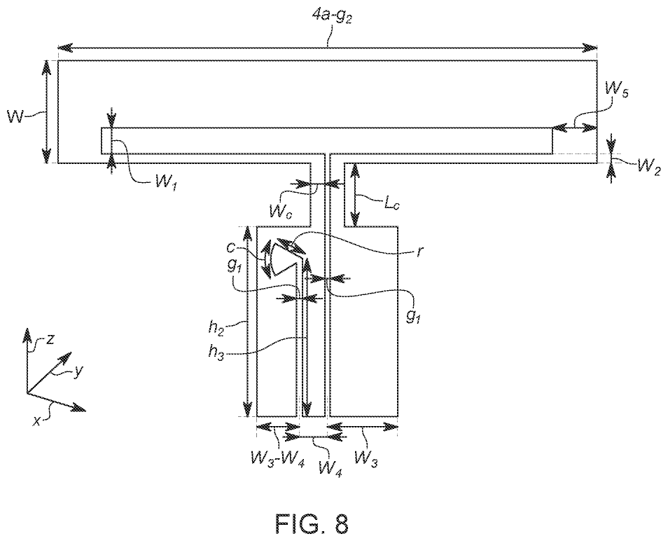

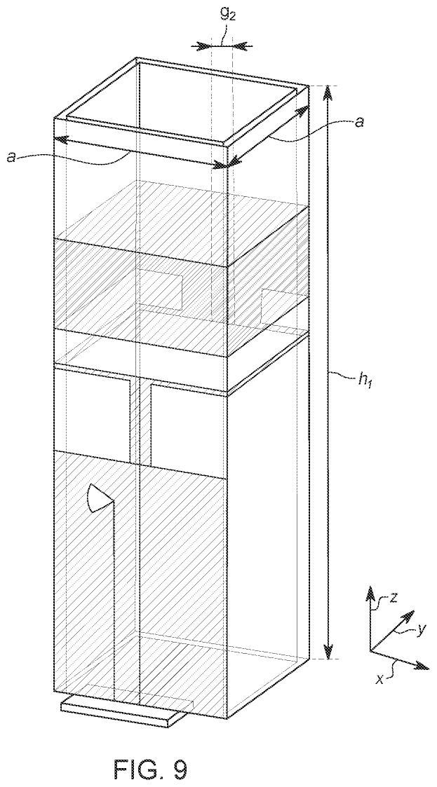

It should be recognized that FIG. 3 is a block diagram and does not illustrate all of the components of the communication receiver 110A-110X. For example, the communication receiver 110A-110X can include one or more antennas, a particular implementation of which will be described in more detail below in connection with FIGS. 8 and 9. The communication receiver 110A-110X can also include a data and/or charging port for exchanging data and/or charging the battery 330. The data and/or charging port can be, for example, a micro USB port. Further, the communication receiver 110A-110X can include a number of passive components, such as resistors and capacitors, as well as buck/boost converters and low dropout (LDO) voltage converters. The communication interfaces 315A and 315B can communicate with the processor 305 using, for example, a UART connection and the sensor(s) 320 can communicate with the processor 305 using, for example, an I2C bus.

FIG. 4 is a schematic diagram of additional components that can be employed in the system. The dashed line in the figure delineates the water (on the left-hand side of the dashed line) and the land (on the right-hand side of the dashed line). The land-based side of the system includes a ground station 405, server 410, and end-user devices 415, all of which are coupled to a network 420, such as the internet or a private network. The ground station 405 can be, for example, a radio tower of a wireless macro network. Thus, if a monitoring tag 105X is within proximity of ground station 405, the monitoring tag 105X can communicate the sensor readings directly to the ground station 405, bypassing the communication receivers 110A-110X. Similarly, one or more of the communication receivers 110A-110X can serve as gateways to the wireless macro network so that sensor readings obtained directly from monitoring tags 105A-105X or that are conveyed from other communication receivers can be provided to server 410 via the ground station 405.

The particular manner of routing within the network of communication receivers 110A-110X and to the ground station 405 can be accomplished in a number of different ways. The communication receivers 110A-110X can be configured with a fixed route through the network of communication receivers 110A-110X. Alternatively, the communication receivers 110A-110X can be configured as a mesh network in which connections between the communication receivers 110A-110X are formed and removed consistent with prevailing communication conditions. In one embodiment the communication receivers 110A-110X employ a priority scheme for determining how to communicate the readings to the server 410. For example, a communication receiver 110A-110X can initially attempt to communicate the readings using the wireless macro network interface to communicate with ground station 405, and if that is unsuccessful the communication receiver 110A-110X can attempt to communicate the readings using the network of communication receivers 110A-110X. Continuing with this example, the LoRa interface can initially be employed to communicate with another one of the communication receivers, and if that fails the Bluetooth interface can be employed. If a communication receiver 110A-110X is unable to communicate readings directly with ground station 405 or directly with one of the other communication receivers, the readings will be maintained in storage until a connection is made and the readings are successfully communicated to either the ground station 405 or another one of the communication receivers.

The server 410 stores and processes the readings and can output them to an end-user device 420, which can be, for example, a desktop computer, laptop computer, tablet, and/or a smartphone. Specifically, the server 410 can expose an API/Script to receive sensor readings and the associated time stamps via network 425 from the monitoring tags 105A-105X, communication receivers 110A-110X, and/or ground station(s) 405. The server 410 stores the sensor readings in a database and processes them for output via a user interface on user device 420. The user interface can, for example, display a list of all monitoring tags stored in the database and allow selection of any of the monitoring tags in the list. Selecting a monitoring tag can produce a list of sensors having readings stored in the database for that particular monitoring tag. The user interface allows a user to then select a sensor, input a date/time range in order to obtain a table and graph of the sensor readings over time and/or a table and map of locations stored by the monitoring tag (the map can include, for example, arrowhead lines showing movement of the marine animal based on the timestamps).

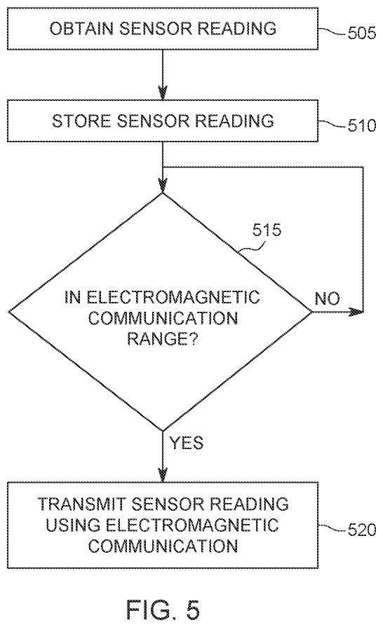

An exemplary method for monitoring a marine animal using a monitoring tag attached to the marine animal will now be described in connection with FIG. 5. Initially, The monitoring tag 105A-105X obtains a reading using at least one sensor 220 of the monitoring tag 105A-105X (step 505). The reading is then stored in a memory 215 of the monitoring tag 105A-105X (step 510). The processor 205 of the monitoring tag 105A-105X determines whether the monitoring tag 105A-105X is within a communication range for radio frequency communication with at least one communication receiver 110A-110X (step 515). Responsive to the processor 205 determining that the monitoring tag 105A-105X is within the communication range for radio frequency communication with the at least one communication receiver 110A-110X (“Yes” path out of decision step 515), the stored readings are transmitted via at least one communication interface 215 of the monitoring tag 105A-105X using radio frequency communication to the at least one communication receiver 110A-110X. The monitoring tag 105A-105X can maintain the readings in the memory 210 until it receives a confirmation that the readings were correctly received, such as an ACKNOWLEDGMENT, HTTP GET/POST, or HTTP SOCKET, etc. The communication receivers 110A-110X can expose a BLE characteristic or LoRa field where data can be written by the monitoring tags 105A-105X and/or other communication receivers.

If the processor 205 determines that the monitoring tag 105A-105X is outside of a communication range for radio frequency communication with at least one communication receiver 110A-110X (“No” path out of decision step 515), the readings are maintained in the memory 210 and the processor 205 continues to determine whether the monitoring tag 105A-105X is within a communication range for radio frequency communication with at least one communication receiver 110A-110X (step 515). Alternatively, if the monitoring tag 105A-105X is equipped with an ultrasonic communication interface, the monitoring tag 105A-105X can transmit the readings using the ultrasonic communication interface when the monitoring tag 105A-105X is outside of a communication range for radio frequency communication with at least one communication receiver 110A-110X.

In order to reduce drag, the monitoring tag 105A-105X is preferably planar. Accordingly, the monitoring tag 105A-105X requires a planar antenna. Because the locations of the monitoring tag 105A-105X and the communication receivers 110A-110X change over time, the planar antenna is preferably quasi-isotropic, i.e., it has a quasi-omnidirectional radiation pattern. Because antennas having a perfectly isotropic radiation pattern are not achievable in practice, a quasi-isotropic antenna is employed, which those skilled in the art will recognize is an antennas whose gain deviation (i.e., the difference between the maximum and minimum gain) is less than 7 dB across the entire radiation sphere. Quasi-isotropic antennas are also sometimes referred to as being near-isotropic. An example of such an antenna is illustrated in FIG. 6. Two orthogonal wire monopoles can be used to provide equivalent electric responses. A Wilkinson divider can be employed to excite the dual orthogonal monopoles (Arm1 and Arm2) with equal magnitude and phase. The divider can be realized only on one side of the substrate by 50 Ohm coplanar waveguide (CPVV) and asymmetrical coplanar strip (ACPS) transmission lines, which consists of CPWACPS tee junction, a pair of ACPS arms, and 2 ACPS outputs except a resistor compared the standard Wilkinson divider.

High Frequency Structure Simulator (HFSS) software was used to simulate this antenna. The resonant frequency mainly depended on the lengths of the dual monopoles L3+L4 and L6+L7. By adjusting the lengths of the monopoles, the surface currents could have equal magnitude and a 90° phase delay with each other. It was found that impedance matching slightly deteriorated as length L5 increased. At the same time, parameter L5 made an important contribution to the quasi-isotropic radiation of the antenna. When parameter L5 was 14 mm, the gain deviation at 2.4 GHz was the best at about 4.75 dB, and the reflection coefficient was also acceptable at the operating band of 2.4 GHz. Other antenna parameters also affected the operating frequency and radiation pattern, and the optimized parameters of the proposed antenna are shown in the table below.

| | Value | | Value | | Value | | Value |
|---|---|---|---|---|---|---|---|
| | (mm) | | (mm) | | (mm) | | (mm) |
| L | 52 | L₅ | 14 | w₂ | 4 | g₃ | 0.9 |
| L₁ | 10 | L₆ | 1 | w₃ | 6 | h₁ | 0.1 |
| L₂ | 22 | L₇ | 29 | w₄ | 15 | h₂ | 0.001 |
| L₃ | 7 | W | 80 | g₁ | 0.1 | h₃ | 0.003 |
| L₄ | 24 | w₁ | 3 | g₂ | 0.1 | h₄ | 0.15 |

It should be recognized that these particular parameters are merely examples and other parameters can be employed. For example, if the surface area available for the antenna is greater or less than that for the design above, these parameters can be scaled. For example, if the available surface area is one-half of that of the design above, each of these parameters can be divided by two. Similarly, if the available surface area is twice that of the design above, each of these parameters can be multiplied by two.

Testing of this antenna demonstrated a communication range of 120 m in air and 12 m in water (the shorter range in water is due to signal losses caused by the water).

In order to evaluate the monitoring system in practice, the antenna's performance in a flexed state was evaluated. The antenna was affixed on a foam cylinder surface with R1=30 mm radius. The impedance matching of the flexed antenna was compared with that in the non-flexed state and it was found that bending operation of the antenna did not affect the resonant frequency, and the −10 dB bandwidth remained at about 0.76 GHz (2.24 GHz-3.0 GHz).

Simulated 3D radiation patterns of the antenna at 2.4 GHz in planar state and in a flexed state were obtained. The gain for the planar case was 2.0 dB and the gain deviation was 4.75 dB. For the flexible case, the gain remained 2.2 dB and the deviation became 6.37 dB, which indicated that the antenna maintains good flexible performance with quasi-isotropic radiation. Integrating the antenna with a balun resulted in the gain being 1.46 dB and the deviation remaining at 7.4 dB, and thus the radiation of the antenna remained quasi-isotropic. This demonstrates that employing an additional balun does not affect the quasi-isotropic radiation characteristic of the proposed antenna.

The antenna can be formed in the following manner. Initially, Ti/Au is deposited on a Si carrier wafer. This material was chosen for ease of removal of the device at the end of the fabrication process. PDMS (thickness=100 μm) can then be spun onto the Si wafer, followed by curing at 75° C. for 75 minutes (FIG. 4 step 2). Because metal adheres poorly to PDMS, PI 2611 can be used to deposit a metal seed layer. This provides mechanical stability to the whole structure in addition to providing the best adhesion properties. PI is then transferred onto the PDMS substrate after being spun to a thickness of ˜10 μm on a second carrier wafer and gradually cured in multiple steps at 90° C., 150° C. and 350° C. for 90 s, 90 s, and 30 min respectively. The cured PI is then transferred onto the PDMS wafer followed by seed layer deposition for the copper growth using ECD. 10 nm of Ti and 150 nm of Au metal can be sputter deposited as a seed layer on PI using 25 sccm of Ar. ECD of Cu is then performed at an average forward current of 210 mA for 30 minutes (˜5 μm), and the growth of Cu can be restricted to only the antenna design pattern using 4 μm thick positive photoresist (PR). After ECD Cu growth, PR is stripped off using acetone and isopropanol followed by rinsing with deionized (DI) water and drying with Nz. The seed layer is removed using physical plasma reactive ion etching (RIE) at 10° C. in the presence of Ar plasma. Final encapsulation of the device to make the antenna waterproof can be performed by spinning 150 μm thick PDMS cured at 75° C. for 75 minutes. The fabricated device can then be peeled from the wafer and placed on the flexible substrate of the monitoring tag 105A-105X.

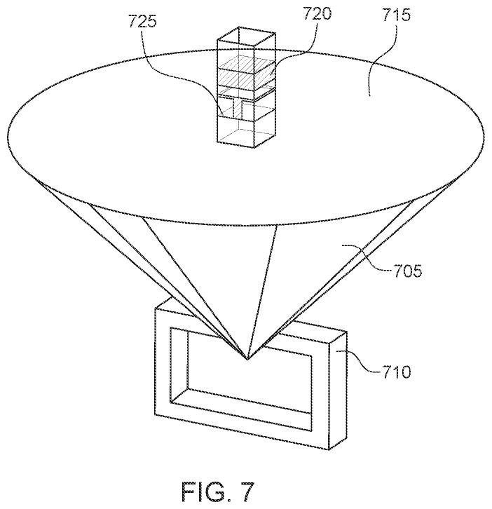

An example of one configuration of a communication receiver is illustrated in FIG. 7. The communication receiver includes a conical upper portion 705 attached to a rectangular bottom portion 710. When in water, the rectangular bottom portion 710 and a lower section of the conical upper portion 705 will be submerged below the water. The conical upper portion 705 has a planar top surface 715 on which the antenna 720 and electronics 725 (described above) are affixed. Because the conical upper portion 705 is sealed with air inside of its structure, the communication receiver will float in water. The combination of the conical upper portion 705 and the rectangular bottom portion 710 helps keep the communication receiver steady at the water surface even if there are waves and wind. Further, arranging the antenna 720 and electronics 725 in the center of the conical upper portion 705 assists in the stability of the communication receiver because the antenna 720 and electronics 725 are placed at the center of gravity of the communication receiver. The communication receiver illustrated in FIG. 7 can be manufactured using any particular technique, such as three-dimensional printing (also referred to as additive manufacturing).

Similar to the antenna of the monitoring tag 105A-105X, it would be desirable for the antenna of the communication receiver to be quasi-isotropic (i.e., having a quasi-omnidirectional radiation pattern). One example of such an antenna is illustrated in FIGS. 8 and 9, where FIG. 9 illustrates the antenna being affixed to a cuboidal structure. Examples of parameters of the antenna are in the table below.

| | Value |
|---|---|
| | (mm) |
| a | 13 |
| w_{c} | 0.7 |
| w₁ | 2.5 |
| w₂ | 0.4 |
| w₃ | 6.5 |
| w₄ | 2 |
| w₅ | 2.1 |
| g₁ | 0.1 |
| g₂ | 1.8 |
| h₁ | 4.2 |
| h₂ | 17.6 |
| h₃ | 14.6 |
| r | 2 |
| t₁ | 0.03 |
| t₂ | 0.09 |
| tₛ | 0.47 |
| tₐ | 0.005 |
| L_{c} | 6 |
| c | $\frac{2}{3} π$ |

It should be recognized that these particular parameters are merely examples and other parameters can be employed. For example, if the surface area available for the antenna is greater or less than that for the design above, these parameters can be scaled. For example, if the available surface area is one-half of that of the design above, each of these parameters can be divided by two. Similarly, if the available surface area is twice that of the design above, each of these parameters can be multiplied by two.

As will be appreciated from FIGS. 8 and 9, the antenna in this example is a simple half wavelength folded dipole. When this folded dipole is meandered in such a way that it can be wrapped on a cuboidal structure, it takes the form of a typical split ring resonator (SRR). The meandered folded dipole is based on SRR structure to take its advantage such as small electrically size. The ratio of the upper and lower dipole widths can be chosen to facilitate impedance matching. The current distribution for both the folded and meandered folded dipoles were found to be similar, i.e., maximum current at the feed point and the minimum current at the end of each arm. This SRR structure generates a pair of orthogonal electrical (\vec{p}) and magnetic (\vec{m}) dipoles simultaneously. The combination of these orthogonal dipoles helps in achieving a quasi-isotropic radiation pattern.

In one example, the cuboidal structure consists of Vero Black Plus (εᵣ=2.8, tan δ=0.02) having a thickness of tₛ=0.47 mm. In a direction perpendicular to the vertical walls of the cuboidal structure, the antenna stack-up comprises three more layers, in addition to the base Vero material. These layers include a 30 μm Kapton (εᵣ=3, tan δ=0.007) layer (for a low-loss material suitable for inkjet printing of the metallic antenna), and a metallic layer (for antenna geometry implementation), which is followed by a 90 μm Kapton layer (to act as a waterproofing layer). This arrangement facilitates the production process, as well as protects the antenna from the water environment. The conductor part of the antenna can be fabricated by inkjet-printing using nano-silver ink having a conductivity of, for example, σ=5.0×10⁶ S/m and a thickness of tₐ=0.005 mm after curing.

This antenna was subject to testing single-ended equipment by integrating a balun. A Perfect Electric Conductor (PEC) was employed at the bottom of the cuboid structure to replicate a Sub Miniature version A (SMA) connector in simulations because it is mostly metallic. A cone structure (illustrated in FIG. 7) is part of the cuboid structure to make the structure buoyant. High Frequency Structure Simulator (HFSS) software was utilized to simulate the antenna. The simulated current distribution on the antenna surface showed that the current distribution on SRR structure is similar to the expected design distribution. Further, testing demonstrated that the antenna, which is designed for the 2.4 GHz frequency, is electrically small with a ka=0.49 and a bandwidth of 70 MHz (2.9%) and that it provided reliable communication over a distance of 240 m in any direction in the azimuthal plane.

The communication receiver can be constructed using, for example, a Objet260 Connex 3D printer by Stratasys® in two independent steps. A thin layer (e.g., 30 μm) of Kapton tape can attached temporarily to a glass slide for ease in inkjet printing. The conductor part can then printed by, for example, a Dimatix Materials inkjet printer (DMP-2831) using nano-silver ink, which can then be cured, for example, at 150° C. for one hour. The Kapton tape can then be removed from the glass slide and attached to the 3D printed cuboid. Another 90 μm Kapton tape can be wrapped on the cuboid for waterproofing purpose. The conical structure can then be integrated with the cuboidal structure.

The disclosed embodiments provide a system and device for monitoring marine animals. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1. A system for monitoring marine animals, the system comprising:
a monitoring tag attachable to a marine animal, wherein the monitoring tag comprises a processor, a memory coupled to the processor, at least one communication interface, and at least one sensor, wherein the processor is configured to store readings from the at least one sensor in the memory; and
at least one communication receiver, wherein the at least one communication receiver comprises a processor, a memory coupled to the processor, and at least one communication interface, and wherein the at least one communication receiver is configured to float in water;
wherein the processor of the monitoring tag is configured to
determine, using the at least one sensor, whether the monitoring tag is within a communication range for radio frequency communication with the at least one communication receiver, and
transmit, via the at least one communication interface of the monitoring tag, the stored readings to the at least one communication receiver responsive to the processor of the monitoring tag determining that the monitoring tag is within the communication range for radio frequency communication with the at least one communication receiver.

2. The system of claim 1, wherein the processor of the monitoring tag is configured to determine that the monitoring tag is within the communication range of the at least one receiver based on reception of an radio frequency communication signal from the at least one communication receiver by the at least one communication interface of the monitoring tag.

3. The system of claim 1, wherein the at least one sensor includes a pressure sensor, wherein the processor is configured to determine that the monitoring tag is within the communication range of the at least one receiver based on readings from the pressure sensor.

4. The system of claim 1, wherein the at least one communication interface of the monitoring tag comprises a plurality of communication interfaces.

5. The system of claim 4, wherein the processor of the monitoring tag is configured to select one of the plurality of communication interfaces for communicating with the at least one communication receiver based on a priority of each of the plurality of communication interfaces.

6. The system of claim 1, wherein the monitoring tag further comprises a battery and an ambient energy collection device coupled to the battery, wherein the ambient energy collection device is configured to generate electricity from ambient energy in an environment of the monitoring tag.

7. The system of claim 6, wherein the ambient energy collection device is solar panel or a kinetic motion energy collection device.

8. The system of claim 1, wherein a first side of the monitoring tag is configured to attached to the marine animal and a second side of the monitoring tag opposite of the first side includes a battery, wherein the monitoring tag further comprises an adhesive arranged on the first side, wherein the battery has a rate useful lifetime and the adhesive is configured so that its adhesion deteriorates sufficiently to release the monitoring tag from the marine animal after the useful lifetime of the battery.

9. The system of claim 1, wherein the processor, memory, at least one communication interface and at least one sensor of the monitoring tag are arranged on a flexible substrate that conforms to a shape of a portion of the marine animal to which the monitoring tag is attached.

10. The system of claim 1, wherein the at least one communication receiver comprises a plurality of communication receivers that form a wireless communication network configured to forward the stored reading to a server.

11. A monitoring tag for monitoring a marine animal, the monitoring tag comprising:
a processor;
a memory coupled to the processor;
at least one communication interface; and
at least one sensor, wherein the processor is configured to store readings from the at least one sensor in the memory,
wherein the processor is configured to
determine, using the at least one sensor, whether the monitoring tag is within a communication range of at least one communication receiver, and
transmit, via the at least one communication interface, the stored readings to the at least one communication receiver responsive to the processor determining that the monitoring tag is within the communication range of the at least one communication receiver.

12. The monitoring tag of claim 11, wherein the processor of the monitoring tag is configured to determine that the monitoring tag is within the communication range of the at least one receiver based on reception of a communication signal by the at least one communication interface of the monitoring tag.

13. The monitoring tag of claim 11, wherein the at least one sensor includes a pressure sensor, wherein the processor is configured to determine that the monitoring tag is within the communication range of the at least one receiver based on readings from the pressure sensor.

14. The monitoring tag of claim 11, wherein the at least one communication interface of the monitoring tag comprises a plurality of communication interfaces.

15. The monitoring tag of claim 14, wherein the processor of the monitoring tag is configured to select one of the plurality of communication interfaces for communicating with the at least one communication receiver based on a priority of each of the plurality of communication interfaces.

16. The monitoring tag of claim 11, wherein the monitoring tag further comprises a battery and an ambient energy collection device coupled to the battery, wherein the ambient energy collection device is configured to generate electricity from ambient energy in an environment of the monitoring tag.

17. A method for monitoring a marine animal using a monitoring tag attached to the marine animal, the method comprising:
obtaining, by the monitoring tag, a reading using at least one sensor of the monitoring tag;
storing the reading in a memory of the monitoring tag;
determining, by a processor of the monitoring tag, whether the monitoring tag is within a communication range for radio frequency communication with at least one communication receiver; and
transmitting, via at least one communication interface of the monitoring tag using radio frequency communication, the stored readings to the at least one communication receiver responsive to the processor determining that the monitoring tag is within the communication range for radio frequency communication with the at least one communication receiver.

18. The method of claim 17, wherein the at least one communication interface includes an radio frequency communication interface and a ultrasonic communication interface, the method further comprising:
transmitting, via the ultrasonic communication interface, the stored reading to the at least one communication receiver responsive to the processor determining that the monitoring tag is outside of the communication range for radio frequency communication with the at least one communication receiver.

19. The method of claim 17, wherein the determination of whether the monitoring tag is within the communication range for radio frequency communication with the at least one communication receiver is based on a pressure reading from the at least one sensor.

20. The method of claim 17, wherein the determination of whether the monitoring tag is within the communication range for radio frequency communication with the at least one communication receiver is based on receipt reception of an radio frequency communication signal by the monitoring tag from the at least one communication receiver.
